(19) United States
(12) Patent Application Publication
(10) Pub. No.: US 2011/0293987 A1
(43) Pub. Date: Dec. 1, 2011

(54) BATTERY TERMINAL CONNECTION SYSTEM

(76) Inventor: Steven Tartaglia, Safety Harbor, FL (US)

(21) Appl. No.: 12/786,478

(22) Filed: May 25, 2010

(51) Int. Cl. H01M 2/30

(52) U.S. Cl. 429/121

(57) ABSTRACT

An application for a battery terminal interface includes a battery terminal interface shield made of a conductive metal having a lower impedance than an impedance of lead. The battery terminal interface shield has an inner surface and an outer surface. The inner surface contacts substantially all of an outer surface of a battery terminal and the outer surface contacts a cable connector, thereby distributing electrical current to/from the cable connector to substantially the entire outer surface of the battery terminal. Since the battery terminal is made from lead and the battery terminal interface shield is made from a better conductor, electric current is better distributed across a greater surface area of the battery terminal.

### FIELD

This invention relates to the field of batteries and more particularly to a system for providing a low-impedance connection to a lead battery terminal.

### BACKGROUND

Battery packs such as flooded lead-acid, absorbed-glass-matt (AGM) and lead-acid often have lead plates that extend out of the battery pack as a lead terminal, so that there is no internal connection between the lead plates and a second metal such as copper.

Since lead-acid varieties of battery packs have very low internal impedance, such batteries are capable of producing very high output currents for, at least, short durations but often continuously. Many lead-acid based battery pack applications include very high current draws through the lead terminals. Because lead has a relatively high resistance, high current flowing through the lead creates several problems. The relatively high resistance coupled with the high current results in a relatively high voltage drop across the terminals and hence since power is the square of the current times the voltage, the power that needs to be dissipated by the terminals is often excessive, leading to reduced power delivered for the intended purposes and heat generation. In that lead has a relatively low melting point, there have been situations in which the battery terminals have melted during peak current draw from certain batteries.

What is needed is a system that will reduce the power loss of the battery terminals thereby increasing power delivery to the intended application and reducing heat generation at the battery terminals.

### SUMMARY

In one embodiment, a battery terminal interface is disclosed including a battery terminal interface shield made of a conductive metal having a lower impedance than an impedance of lead. The battery terminal interface shield has an inner surface and an outer surface. The inner surface contacts substantially all of an outer surface of a battery terminal and the outer surface contacts a cable connector, thereby distributing electrical current to/from the cable connector to substantially the entire outer surface of the battery terminal.

In another embodiment, a battery terminal interface is disclosed including a battery with battery terminals made of lead that having an outer surface. A cable connector is provided for connecting the battery terminals to a device that is powered by the battery. Battery terminal interface shields that are made of a conductive metal having a lower impedance than the impedance of lead are fitted on the battery terminals. Each of the battery terminal interface shields fit over one of the battery terminals, the inner surface of the battery terminal interface shields contacting substantially all of the outer surface of the battery terminals and an outer surface of the battery terminal interface shield electrically and physically connected to one of the cable connectors.

In another embodiment, a battery terminal interface is disclosed including a battery having two battery terminals made of lead. Each of the battery terminals have a horizontal planar top surface, three substantially vertical planar sides that meet at substantially right angles and one curved vertical side. There are two cable connectors for connecting the battery terminals to a device that is powered by the battery and two battery terminal interface shields made of a conductive metal having a lower impedance than the impedance of lead. Each of the battery terminal interface shields have a horizontal planar top inside surface, three substantially vertical planar inside walls that meet at substantially right angles and one curved vertical inside wall. Each of the battery terminal interface shields fit over one of the battery terminals such that for each battery terminal interface shield, the horizontal planar top inside surface electrically contacts the horizontal planar top surface of one of the battery terminals, the three substantially vertical planar inside walls electrically contact the three substantially vertical planar sides of the one of the battery terminals and the curved vertical inside wall electrically contacts the curved vertical side of the one of the battery terminals. Each of the cable connectors electrically contact one of the battery terminals such that electric current to/from each of the cable connectors is distributed to the horizontal planar top surface, the three substantially vertical planar sides and the curved vertical inside wall and the curved vertical side of one of the battery terminals.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of an existing battery connection system.

FIG. 1A illustrates a perspective view of a battery connection with a battery terminal interface system.

FIG. 2 illustrates a perspective view of a battery terminal interface for decreasing overall impedance of a battery terminal.

FIG. 3 illustrates a top plan view of typical battery terminal interface for decreasing overall impedance of a battery terminal.

FIG. 4 illustrates a front plan view of the typical battery terminal interface for decreasing overall impedance of a battery terminal.

FIG. 5 illustrates a perspective view of another typical battery and terminal connection with a second typical battery terminal interface for decreasing overall impedance of a battery terminal.

FIG. 6 illustrates a perspective view of a third typical battery and terminal connection with a second typical battery terminal interface for decreasing overall impedance of a battery terminal.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

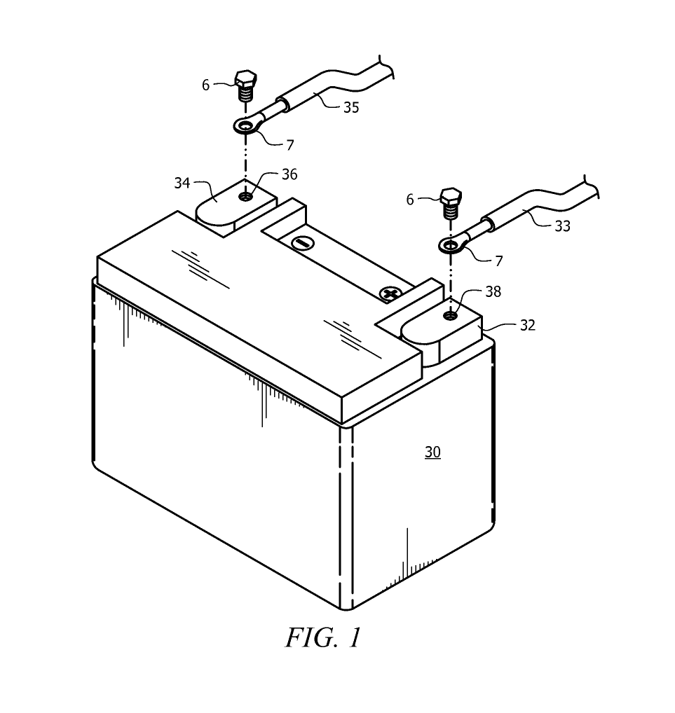

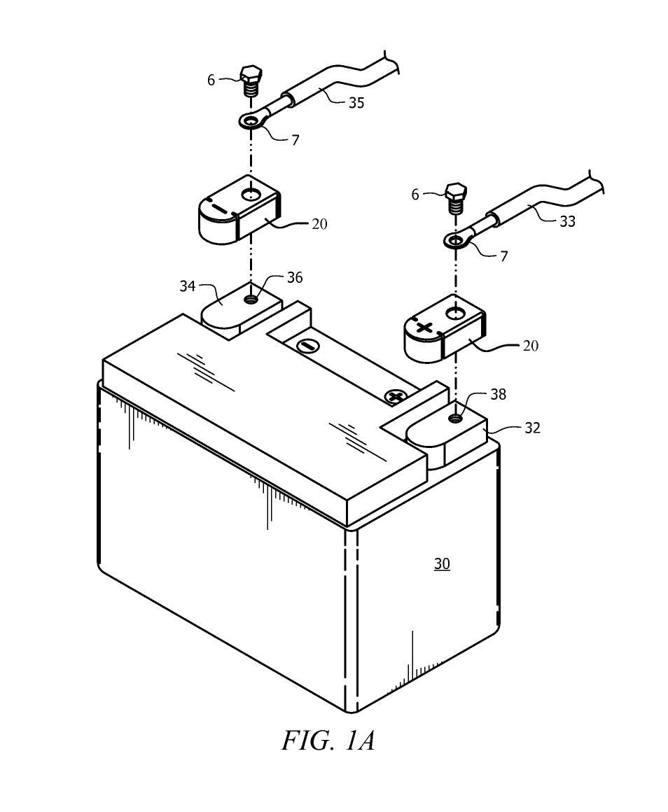

Referring to FIG. 1, a perspective view of a typical lead-based battery 30 is shown. Many lead-based (e.g. flooded lead-acid, absorbed-glass-matt (AGM), lead-acid and lead-acid derivative) batteries 40 have a positive 32 and negative 34 battery terminal made of lead. In this example, each terminal 32/34 has a threaded hole 36/38 for accepting a screw 6 that holds connection terminals 7 against the battery terminals 32/34. The connection terminals 7 are connected to power cables 33/35. Since lead has a relatively high impedance (approximately 10 times that of copper) and the screws 6 and terminals 7 only contact a small area of the battery terminals 32/34, there is a relatively high resistance between the connection terminals/screws and the internal plates of the battery 30 (not visible).

In high current applications such as starter motor cranking, where the battery 30 is called upon to deliver, for example, hundreds of amperes of current to a starter motor, any resistance of the battery terminals 32/34 reduces power that is needed, for example, in turning the starting motor. For example, in a 12V battery with an the overall terminal resistance of each terminals 32/34 of 0.01 ohms, a 200 amps current draw required to run a starting motor results in a 2 volt drop over each terminal 32/34 as calculated by V=IR or, V=200 A*0.01Ω. Since power is equal to the current times the voltage drop, the power dissipated by each terminal 32/34 is 400 Watts (P=V*1 or 2V*200 A)−800 Watts total when both terminals are included. The 400 watts per terminal is dissipated as heat instead of being used to turn the starting motor. Also, since each terminal drops 2 volts, for a 12V battery, the 2 volt drop per terminal results in only 8V delivered to the starting motor.

If the heat is not adequately removed from the lead battery terminals, the heat has the potential of melting the lead battery terminals.

A 10% decrease in the impedance of the battery terminal interface will result in a 10% decrease in the power dissipated by each of the battery terminals 32/34. In the above scenario, the voltage drop over each terminal is calculated as 200 A*0.09Ω (10% less resistance) or 1.8V and the power dissipated by each terminal 32/34 is 360 Watts (200 A*1.8V)−720 Watts when both terminals are included. Hence, even a small decrease in battery terminal impedance results in a significant decrease in power dissipated over the battery terminals 32/34, a significant reduction in heat generated during high current peaks and an increase in power and voltage delivered to the application.

Referring to FIG. 1A, a perspective view of a battery connection with a battery terminal interface system is shown. The battery terminal interface includes a battery terminal interface shield 20 that is made of a conductive material such as copper, brass, etc, preferably a material that has a lower impedance than that of lead. In some embodiments, the battery terminal interface shield 20 has one or more holes for passing screws 6 through to threaded holes 36/38 in the battery terminals 32/34.

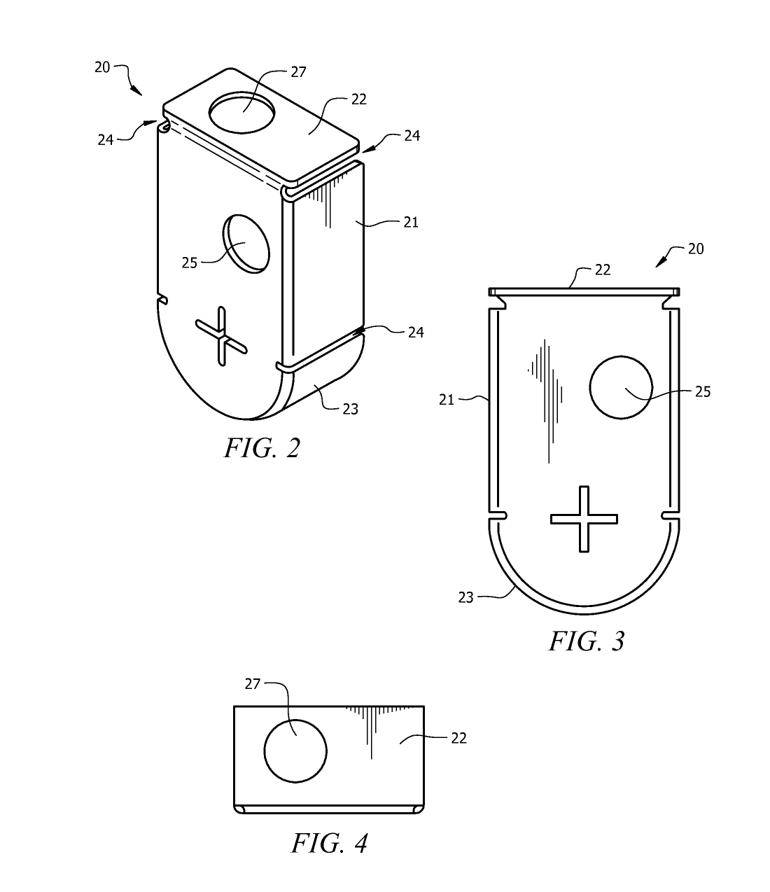

The battery terminal interface shield 20 is shaped and sized to fit tightly around the battery terminal 32/34 of, for example, the battery 30. It is anticipated that, in some embodiments, the battery terminal interface shield 20 is made of a material that is resilient and applies force, keeping one or more inside walls of the battery terminal interface shield 20 in contact with as much surface area of the lead battery terminals 32/34 as possible. For example, the battery terminal interface shield 20 has cuts or openings 24 (see FIG. 2) in the side walls 21/22/23 so that the sides 21/22/23 form resilient sides that hold tightly against the lead battery terminals 32/34.

The battery terminal interface shield 20 reduces the impedance between the internal battery plates (anode and cathodes) and a connector 7 and screws 6 that are screwed through the connector 7 and into one of the threaded holes 36/38. Lead has a relatively higher impedance than many other metals such as copper, nickel and brass. Impedance values are typically provided in scientific tables for a given length and area of each material since direct current flows through the entire area of a conductive material. The impedance of lead for a given length and cross sectional area is 2.2×10⁻⁷ while for the same length and area, copper is 1.68×10⁻⁸, brass is 3.5×10⁻⁸ and nickel is 6.99×10⁻⁸ (at 20° C.). Using copper as a material for the battery terminal interface shield 20, the impedance of lead is approximately 13 times that of an equivalent area and length of copper. Although, determining the actual impedance of a connection between a small area of the surface and one of the threaded holes 36/38 to the internal plates of the battery pack 30 is complicated due to many different path lengths and cross sectional areas, it can be understood that by distributing the current over a greater area of the battery terminal will reduce the total impedance between the connector 7, cable 33/35 and the internal plates of the battery pack 30. Furthermore, current flow through the battery terminals 32/34 creates heat, the impedance of lead (and copper) increases with heat at approximately 0.39% per degree over 20° C. Therefore, the resistance of lead is around 2.372×10⁻⁷ for the same area at 40° C., as opposed to 2.2×10⁻⁷ at 20° C.

For example, implementing a copper battery terminal interface shield 20, having 13 times lower impedance than lead, will distribute power through contact points along many surfaces of the lead battery terminals 32/34, thereby increasing the overall cross-sectional area and/or decreasing the overall length of the electrical path between the cable connector 7 and the internal plates of the battery pack 30. The result is a lower impedance between the cable connector 7 and the internal plates of the battery pack 30 which, in turn, reduces power loss through the battery terminals 32/34 and reduces heating of the battery terminals 32/34. The reduced heating also leads to reduced power loss because, as shown above, as the lead battery terminals 32/34 are heated, the impedance of the lead terminals 32/34 increases, further increasing power loss and further increasing heating of the lead battery terminals 32/34. For some applications, the battery terminal interface shield 20 reduces heating enough to prevent melting of some lead battery terminals 32/34.

Referring to FIG. 2, a perspective view of a typical battery terminal interface shield 20 for decreasing overall impedance of a battery terminal connection is shown. The battery terminal interface shield 20 is a cover that is made of a conductive material such as copper, brass, etc, preferably a material that has a lower impedance than that of lead. The battery terminal interface shield 20 has one or more holes 25/27 for connecting a cable terminal 7 to threaded holes 36/38 in the battery terminals using screws 6.

The battery terminal interface shield 20 is shaped and sized to fit tightly around the battery terminal 32/34 of, for example, the battery 30 (see FIG. 1). It is anticipated that, in some embodiments, the battery terminal interface shield 20 is made of a material that is resilient and applies force, keeping an inside one or more inside walls of the battery terminal interface shield 20 in contact with the lead battery terminals 32/34. For example, the battery terminal interface shield 20 has cuts or openings 24 in the side walls 21/22/23 so that the sides 21/22/23 form resilient sides that hold tightly against the lead battery terminals 32/34.

The battery terminal interface shield 20 reduces the impedance between a connector screwed into one of the threaded holes 36/38 and the plates (anode and cathodes) of the internal battery. It is preferred, though other materials also perform well, to use copper as a material for the battery terminal interface shield 20 because the impedance of lead is approximately 13 times that of an equivalent area and length of copper. The battery terminal interface shield 20 distributes the current load over a greater area of the battery terminal, thereby reducing the total impedance between the connector 7 and the internal plates of the battery pack 30. Furthermore, current flow through the battery terminals 32/34 creates heat. The impedance of lead (and copper) increases with heat at approximately 0.39% per degree over 20° C. Therefore, impedance increases as the terminals 32/34 heat, reducing available power output and creating additional heat at the terminals 32/34.

For example, implementing a copper battery terminal interface shield 20, having 13 times lower impedance than lead, will distribute power through contact points along many surfaces of the lead battery terminals 32/34, thereby increasing the overall area and/or decreasing the overall length of the electrical path between the cable/connector and the internal plates of the battery pack 30. The result is a lower impedance between the cable/connector and the internal plates of the battery pack 30 which, in turn, reduces power loss through the battery terminals 32/34 and reduces heating of the battery terminals 32/34. The reduced heating also leads to reduced power loss because, as shown above, as the lead battery terminals 32/34 are heated to, for example, 40° C., the impedance of the lead terminals 32/34 increases, further increasing power loss and further increasing the temperature of the lead battery terminals 32/34. For some applications, the battery terminal interface shield 20 reduces heating enough to prevent melting of some lead battery terminals 32/34.

Referring to FIG. 3, a top plan view of typical battery terminal interface shield 20 for decreasing overall impedance of a battery terminal 32/34 is shown. The battery terminal interface shield 20 is a cover that is made of a conductive material such as copper, brass, etc, preferably a material that has a lower impedance than that of lead. The battery terminal interface shield 20 has one or more holes 25 for connecting a cable terminal 7 to threaded holes 36/38 in the battery terminals using screws 6. The walls 21/22/23 are formed, molded or bent to fit tightly around the battery terminals 32/34. In this embodiment, there are three planar vertical walls 21/22 and one curved vertical wall 23. Current flows between the cable connector 7 and the battery terminal interface shield 20 through the battery terminal interface shield 20 to many contact points distributed around the battery terminals 32/34, thereby distributing the flow of current and resulting in an overall decrease in the impedance/resistance between the internal battery plates and the cable connector 7.

Referring to FIG. 4, a front plan view of the typical battery terminal interface shield 20 for decreasing overall impedance of a battery terminal is shown. The optional hole 27 is cut or formed for battery packs 30 that have side threaded holes for accepting the screws 6 and cable connectors 7.

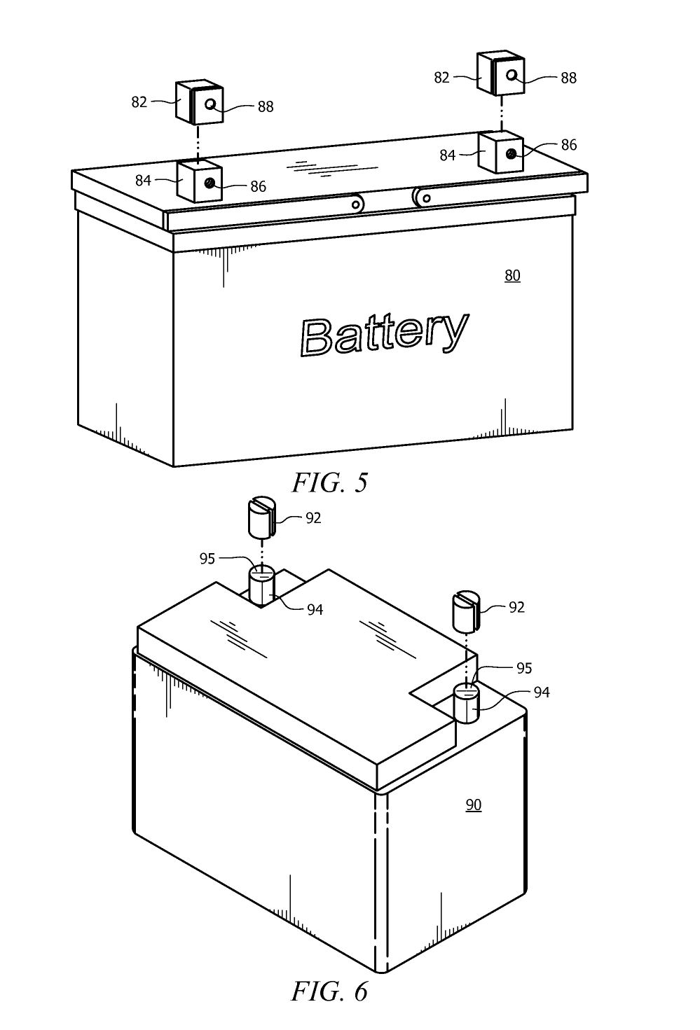

Referring to FIG. 5, a perspective view of another typical battery 80 and terminal connection with a second typical battery terminal interface 82 for decreasing overall impedance of battery terminals 84 is shown. In this example, the battery terminals 84 are square or rectangular and the battery terminal interface 82 fits tightly over the battery terminals 84, making contact on all sides, thereby reducing the impedance of the battery terminal interface to cable connectors 7 and screws 6, the screws passing through holes 88 in the battery terminal interface 82 and into the threaded holes 86 in the battery terminals 84.

Referring to FIG. 6, a perspective view of a third typical battery 90 and terminal connection with a third battery terminal interface 92 for decreasing overall impedance of a battery terminal 94 is shown. In this example, the battery terminals 94 are cylindrical. In the past, metal connectors were tightened around the circumference of the cylindrical battery terminals 94, making contact with circumferential edges of the battery terminals 94. The prior connectors did not contact the top surface 95 of the battery terminals 94. The battery terminal interface 92 reduces the impedance/resistance of the battery terminal interface by conducting power evenly to more surface area of the battery terminals 94, including the top surface 95.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A battery terminal interface comprising:
a battery terminal interface shield made of a conductive metal having a lower impedance than an impedance of lead, the battery terminal interface shield having an inner surface and an outer surface, the inner surface contacting substantially all of an outer surface of a battery terminal and the outer surface contacting a cable connector, thereby distributing electrical current to/from the cable connector to substantially all of the outer surface of the battery terminal.

2. The battery terminal interface of claim 1, wherein the conductive metal is brass.

3. The battery terminal interface of claim 1, wherein the conductive metal is copper.

4. The battery terminal interface of claim 1, wherein one or more holes are formed in the battery terminal interface shield through which screws tightened into threaded holes of the battery terminal hold a connector against the battery terminal interface shield.

5. The battery terminal interface of claim 1, wherein the conductive metal is a resilient conductive metal and the resilient conductive metal holds the inner surfaces in contact with substantially the entire outer surface of the battery terminal.

6. A battery terminal interface comprising:
a battery having battery terminals made of lead, the battery terminals having an outer surface;
a cable connector for connecting the battery terminals to a device that is powered by the battery; and
battery terminal interface shields made of a conductive metal having a lower impedance than the impedance of lead, each of the battery terminal interface shields fitting over one of the battery terminals, the inner surface of the battery terminal interface shields contacting substantially all of the outer surface of the battery terminals and an outer surface of the battery terminal interface shield electrically and physically connected to one of the cable connectors.

7. The battery terminal interface of claim 6, wherein the conductive metal is brass.

8. The battery terminal interface of claim 6, wherein the conductive metal is copper.

9. The battery terminal interface of claim 6, wherein one or more holes are formed in the battery terminal interface shields through which screws tightened into threaded holes of the battery terminals, holding the cable connectors against the battery terminal interface shields.

10. The battery terminal interface of claim 6, wherein the conductive metal is a resilient conductive metal and the resilient conductive metal holds the inner surfaces in contact with substantially the entire outer surface of each of the battery terminals.

11. A battery terminal interface comprising:
a battery having two battery terminals made of lead, each of the battery terminals having a horizontal planar top surface, three substantially vertical planar sides that meet at substantially right angles and one curved vertical side;
two cable connectors for connecting the battery terminals to a device that is powered by the battery; and
two battery terminal interface shields made of a conductive metal having a lower impedance than the impedance of lead, each of the battery terminal interface shields having a horizontal planar top inside surface, three substantially vertical planar inside walls that meet at substantially right angles and one curved vertical inside wall, each of the battery terminal interface shields fitting over one of the battery terminals such that for each battery terminal interface shield, the horizontal planar top inside surface electrically contacts the horizontal planar top surface of one of the battery terminals, the three substantially vertical planar inside walls electrically contact the three substantially vertical planar sides of the one of the battery terminals and the curved vertical inside wall electrically contacts the curved vertical side of the one of the battery terminals and
each of the cable connectors electrically contact one of the battery terminals,
whereas electric current to/from each of the cable connectors is distributed to the horizontal planar top surface, the three substantially vertical planar sides and the curved vertical inside wall and the curved vertical side of one of the battery terminals.

12. The battery terminal interface of claim 11, wherein the battery terminal interface shields has one or more vertical slits, the slits allowing the battery terminal interface shields to open and tightly fit around the battery terminal.

13. The battery terminal interface of claim 11, wherein the conductive metal is brass.

14. The battery terminal interface of claim 11, wherein the conductive metal is copper.

15. The battery terminal interface of claim 11, wherein one or more holes are formed in the battery terminal interface shields through which screws tightened into threaded holes of the battery terminals, holding the cable connectors against the battery terminal interface shields.

16. The battery terminal interface of claim 11, wherein the conductive metal is a resilient conductive metal and the resilient conductive metal holds the inner surfaces in contact with substantially the entire outer surface of each of the battery terminals.
